(19) United States
(12) Patent Application Publication
(10) Pub. No.: US 2015/0233290 A1
(43) Pub. Date: Aug. 20, 2015

(54) PROCESS FOR PRODUCING HYDROGEN AND GENERATING POWER

(71) Applicant: SHELL OIL COMPANY, Houston, TX (US)

(72) Inventors: Salvador Aldrett Lee, Amsterdam (NL); Nikunj Gupta, Bangalore (IN); Karel Martin Kapoun, Amsterdam (NL)

(21) Appl. No.: 14/433,074

(22) PCT Filed: Oct. 3, 2013
(86) PCT No.: PCT/EP2013/070606

§ 371 Date: Apr. 2, 2015

(30) Foreign Application Priority Data
Oct. 4, 2012 (EP) 12187243.6

(51) Int. Cl. F02C 3/22; C01B 3/50; F02C 3/28; C01B 3/34

(52) U.S. Cl. CPC F02C 3/22; C01B 3/346; C01B 3/50; F02C 3/28; C01B 2203/0216; C01B 2203/0283; C01B 2203/0475; C01B 2203/0811; C01B 2203/0872; C01B 2203/1235; C01B 2203/1241; C01B 2203/84

(57) ABSTRACT

A process for producing hydrogen and power comprises subjecting a gaseous hydrocarbon feedstock to an endothermic steam reforming reaction by contacting the feedstock, in a reaction zone, in the presence of steam, with catalyst to obtain a mixture comprising hydrogen and carbon monoxide; recovering hydrogen from the mixture; feeding fuel and oxidant to a turbine system comprising a compressor, combustion chamber and expansion turbine, wherein the compressor is coupled to the turbine, the oxidant is compressed in the compressor to obtain compressed oxidant, and the fuel is combusted with the compressed oxidant in the chamber to obtain a stream of combusted gas; feeding at least part of the stream to the turbine to generate power and to obtain a turbine flue gas; and providing heat for the reforming reaction from the combusted gas and/or the flue gas; and liquefaction of the recovered hydrogen by subjecting it to a liquefaction cycle.

### FIELD OF THE INVENTION

The invention relates to a process for producing hydrogen and generating power.

### BACKGROUND TO THE INVENTION

Hydrogen is an important industrial gas used in oil refining processes and also in chemical processes. It is to be expected that hydrogen will be increasingly important as energy carrier, in particular in the field of transportation. For transportation, it may be advantageous to use hydrogen in liquid form. Liquefaction of hydrogen involves refrigeration and compressing of hydrogen and is a very energy-consuming process.

Most hydrogen is currently produced via steam reforming of natural gas due to the relatively low costs of the process. Steam reforming is a strongly endothermic process. The heat needed for the process is typically provided by combusting part of the natural gas feed in a furnace. Also recycle methane in tail gas from a downstream pressure swing absorption unit is usually fed to the furnace. An important disadvantage of combusting fuel like natural gas in a dedicated furnace to provide the heat needed for the steam reforming reaction is that the exergetic value of the fuel is only partially used.

### SUMMARY OF THE INVENTION

It has now been found that by integrating hydrogen manufacture by means of steam reforming with power generation by means of one or more turbines, the exergetic value of the fuel that is traditionally burned in the furnace of a steam reformer can be used to generate power whilst using the residual heat generated in the turbine to provide the heat needed for the endothermic steam reforming reaction. Accordingly, the present invention provides a process for producing hydrogen and generating power comprising the following steps:
(a) subjecting a gaseous hydrocarbon feedstock to an endothermic steam reforming reaction by contacting the hydrocarbon feedstock, in a steam reforming reaction zone, in the presence of steam, with a steam reforming catalyst under steam reforming conditions to obtain a gaseous mixture comprising hydrogen and carbon monoxide;
(b) recovering hydrogen from the mixture;
(c) feeding a fuel and an oxidant to a turbine comprising in series a compressor, a combustion chamber and an expansion turbine, wherein the compressor is coupled to the expansion turbine, wherein the oxidant is compressed in the in the compressor to obtain compressed oxidant and the fuel is combusted with the compressed oxidant in the combustion chamber to obtain a stream of combusted gas;
(d) feeding at least part of the stream of combusted gas to the expansion turbine to generate power and to obtain a turbine flue gas; and
(e) providing heat for the endothermic reforming reaction by bringing a hot gas stream generated in step (c) and/or step (d) in heat exchange contact with the steam reforming reaction zone; and
(f) liquefaction of the hydrogen recovered in step (b) by subjecting the hydrogen recovered to a liquefaction cycle comprising cooling and compressing the hydrogen.

An important advantage of the process according to the invention as compared to a conventional steam reforming process wherein fuel is combusted in a furnace dedicated for heating the steam reforming reactor, is that better use is made of the exergetic value of the fuel. This extra efficiency allows for additional power generation for the same amount of fuel.

Moreover, the integrated steam reforming and turbine can advantageously be further integrated with a liquefaction cycle for the hydrogen produced. The power generated may provide part of the power needed in the liquefaction cycle. Alternatively or additionally, power generated by feeding steam produced in the process, i.e. by cooling the synthesis gas from the steam reformer and/or the turbine flue gas, to a steam turbine may be used in the liquefaction cycle. In a preferred embodiment, such steam turbine is connected through a driver to one or more compressors in the liquefaction cycle. Thus, less electricity is needed to drive such compressors.

### BRIEF DESCRIPTION OF THE DRAWINGS

FIGS. 1 and 2 each schematically show a process according to the invention.

### DETAILED DESCRIPTION OF THE INVENTION

In the process according to the invention, hydrogen is produced by subjecting a gaseous hydrocarbon feedstock to an endothermic steam reforming reaction and power is generated by feeding a fuel and an oxidant to a turbine. A hot gas stream generated in the turbine is used to provide the heat needed for the endothermic steam reforming reaction.

In steam reforming step (a), a gaseous hydrocarbon feedstock is subjected to a steam reforming reaction by contacting the feedstock, in a steam reforming reaction zone, in the presence of steam, with a steam reforming catalyst under steam reforming conditions. As a result of the steam reforming reaction, a gaseous mixture comprising hydrogen and carbon monoxide, usually referred to as synthesis gas, is formed. The gaseous mixture may further comprise carbon dioxide, excess steam and unconverted hydrocarbon feedstock.

Steam reforming of hydrocarbons or other hydrocarbon feedstocks is well-known in the art. The steam reforming catalyst may be any steam reforming catalyst known in the art. Suitable examples of such catalysts are catalysts comprising a Group VIII metal supported on a ceramic or metal catalyst carrier, preferably supported Ni, Co, Pt, Pd, Ir, Ru and/or Ru. Nickel-based catalysts, i.e. catalysts comprising nickel as catalytically active metal, are particularly preferred and are commercially available. The steam reforming reaction zone preferably comprises a fixed bed of catalyst particles, more preferably arranged in a number of parallel tubes, each tube containing a fixed bed of steam reforming catalyst particles. Prior art steam reforming units typically comprise a steam reforming reaction zone and a furnace. The heat needed for the endothermic reaction carried out in the steam reforming reaction zone is then provided by a furnace fueled by a fuel gas. In the process according to the invention, a hot gas stream generated in the turbine is brought in heat exchange contact with the steam reforming reaction zone in order to provide the heat needed for the endothermic reactor. Any suitable arrangement for catalyst may be used in the steam reforming reaction zone.

Any suitable steam reforming conditions known in the art may be used in step (a). Preferably, the steam reforming conditions comprise an operating temperature in the range from 550 to 1,050° C., more preferably in the range from 550 to 950° C., even more preferably from 600 to 850° C. Reference herein to the operating temperature is to the averaged catalyst bed temperature. Preferably the steam reforming conditions comprise a pressure in the range from 1 to 40 bar (absolute), more preferably from 10 to 30 bar (absolute).

Any suitable hydrocarbon feedstock and any suitable steam-to-feedstock ratio may be used.

Preferred feedstocks are hydrocarbon feedstocks such as natural gas, methane, ethane, propane, liquefied propane gas (LPG), biogas, or combinations of two or more thereof. Natural gas is a particularly preferred feedstock.

From the gaseous mixture obtained in steam reforming step (a), hydrogen is recovered in step (b). Recovery of hydrogen, i.e. obtaining hydrogen in a more purified form, may be done by any suitable means known in the art.

In step (c) of the process according to the invention, a fuel and an oxidant are fed to a turbine comprising in series a compressor, a combustion chamber and an expansion turbine, wherein the compressor is driven through coupling to the expansion turbine. Preferably, the expansion turbine is directly connected to an electric generator.

The oxidant is compressed in the compressor to obtain compressed oxidant and the fuel is combusted with the compressed oxidant in the combustion chamber to obtain a stream of combusted gas. Such combusted gas has a very high temperature, typically in the range from 1300 to 1600° C. In step (d), at least part of the combusted gas is fed to the expansion turbine. In case the expansion turbine is directly connected to an electric generator, electrical power is generated in step (d). Alternatively, shaft power may be generated in step (d). Further, a turbine flue gas, typically having a temperature in the range from 800 to 1200° C., is obtained in the expansion turbine.

The fuel fed to the turbine may be any gaseous fuel known to be suitable as turbine feed. Preferably, the turbine is a gas turbine and the fuel is a gaseous fuel. Preferred fuels include hydrogen and hydrocarbon fuels such as natural gas, methane, ethane, propane, liquefied propane gas (LPG), and biogas, hydrogen, or combinations of two or more thereof. Natural gas is a particularly preferred fuel.

In step (e), heat needed for the endothermic reforming reaction is provided by bringing a hot gas stream generated in step (c) and/or step (d) in heat exchange contact with the steam reforming reaction zone.

In one embodiment of the invention, the hot gas stream is turbine flue gas obtained in step (d). All or part of the turbine flue gas obtained in step (d) may be used for heat exchange with the steam reforming reaction zone. Preferably, part of the part of the turbine flue gas obtained in step (d) is used for heat exchange with the steam reforming reaction zone.

After heat exchange contact of turbine flue gas with the steam reforming reaction zone, cooled turbine flue gas is obtained. The cooled turbine flue gas may be further cooled by bringing the cooled turbine flue gas in heat exchange contact with water to generate steam.

In another embodiment of the invention, the hot gas stream is a part of the stream of combusted gas obtained in step (c). Preferably, the major part of the stream of combusted gas obtained in step (c) is directly fed to the expansion turbine to generate power in step (d) and only a minor part is used as the hot gas to provide heat for the steam reforming reaction. More preferably, in the range from 50 to 98%, even more preferably from 70 to 95%, of the stream of combusted gas is directly fed to the expansion turbine. Preferably, the cooled combusted gas obtained after heat exchange contact of the hot gas stream with the steam reforming reaction zone, is supplied to the expansion turbine. This will typically be done by combining the cooled combusted gas with combusted gas leaving the combustor and feeding such combined stream to the expansion turbine to generate power in step (d).

Any turbine flue gas not used as the hot gas stream to provide heat for the steam reforming reaction is preferably used to generate steam. This is done by cooling such turbine flue gas by bringing it in heat exchange contact with water.

In hydrogen recovery step (b), the gaseous mixture obtained in step (a) is preferably subjected to a water-gas shift reaction. In the water-gas shift reaction, carbon monoxide in the gaseous mixture obtained in steam reforming is reacted with steam to be converted into carbon dioxide and additional hydrogen. Thus, a water-gas shifted gaseous mixture is obtained that comprises hydrogen and carbon dioxide. The steam is preferably a combination of excess steam present in the gaseous mixture obtained in the steam reforming step and additional steam. The additional steam may be external steam, but preferably is steam generated in the process according to the invention.

The water-gas shift reaction is well-known in the art. Any suitable reaction conditions and catalysts known in the art may be applied. Typically, the water-gas shift reaction is carried out in two stages, a first stage (HTS: High Temperature Shift) at a temperature in the range from 300 to 450° C. and a second stage at a lower temperature (LTS: Low Temperature Shift), typically in the range from 180 to 250° C. Since the gaseous mixture obtained in steam reforming step (a) typically has a temperature that is higher than the temperature in the first stage of the water-gas shift reaction, the gaseous mixture obtained in step (a) is typically cooled before being subjected to a water-gas shift reaction. Preferably, the gaseous mixture is cooled to a temperature in the range from 300 to 450° C. If the water-gas shift reaction is carried out at a lower temperature, the gaseous mixture is preferably cooled to a lower temperature.

Hydrogen recovery step (b) preferably further comprises a carbon dioxide removal step wherein carbon dioxide is removed from the water-gas shifted gaseous mixture to obtain a gaseous stream enriched in hydrogen. The carbon dioxide removal may be done by any means known in the art, for example by membrane separation, amine extraction, pressure swing absorption or condensation of carbon dioxide in a cooling step.

In order to obtain a stream further enriched in hydrogen, the hydrogen recovery step may comprise a subsequent pressure swing adsorption step wherein the gaseous stream obtained after the carbon dioxide removal step is subjected to pressure swing adsorption to obtain a high purity hydrogen stream and a low purity hydrogen stream comprising hydrocarbon. Pressure swing adsorption for hydrogen purification is well-known in the art.

The process according to the invention comprises a step (f) wherein the hydrogen recovered in step (b) is liquefied by subjecting the hydrogen recovered to a liquefaction cycle comprising cooling and compressing the hydrogen.

Liquefaction of hydrogen and liquefaction cycles suitable for hydrogen liquefaction are known in the art. Any suitable liquefaction cycle known in the art may be used, including the Claude cycle, Brayton cycle, Joule Thompson cycle and any modifications or combinations thereof.

Preferably, steam generated in the process according to the invention, i.e. steam generated in cooling turbine flue gas, optionally after heat exchange contact with the steam reforming zone, steam generated by cooling the gaseous mixture obtained in the steam reforming step before it is subjected to a water-gas shift reaction or steam generated in any further cooling steps between the water-gas shift step and hydrogen liquefaction, is fed to a steam turbine. The steam turbine may be directly connected to an electric generator to generate electrical power. Alternatively and preferably, the steam turbine is driving a compressor used for the compressing in hydrogen liquefaction step (f). The steam turbine then directly provides shaft work for the liquefaction compressor. The steam turbine to which steam generated in the process is fed, may be a stand-alone steam turbine. Preferably, however, the steam turbine is combined with the turbine providing the hot gas stream for heating the steam reforming reaction zone in a combined cycle power generator.

The power generated in step (d) of the process according to the invention and/or the power generated by the steam turbine, if any, is preferably used for cooling and/or compressing the hydrogen in hydrogen liquefaction step (f).

Facilities to produce liquid hydrogen according to the invention can be located onshore or offshore, much like the currently fixed or floating LNG options.

### DETAILED DESCRIPTION OF THE DRAWINGS

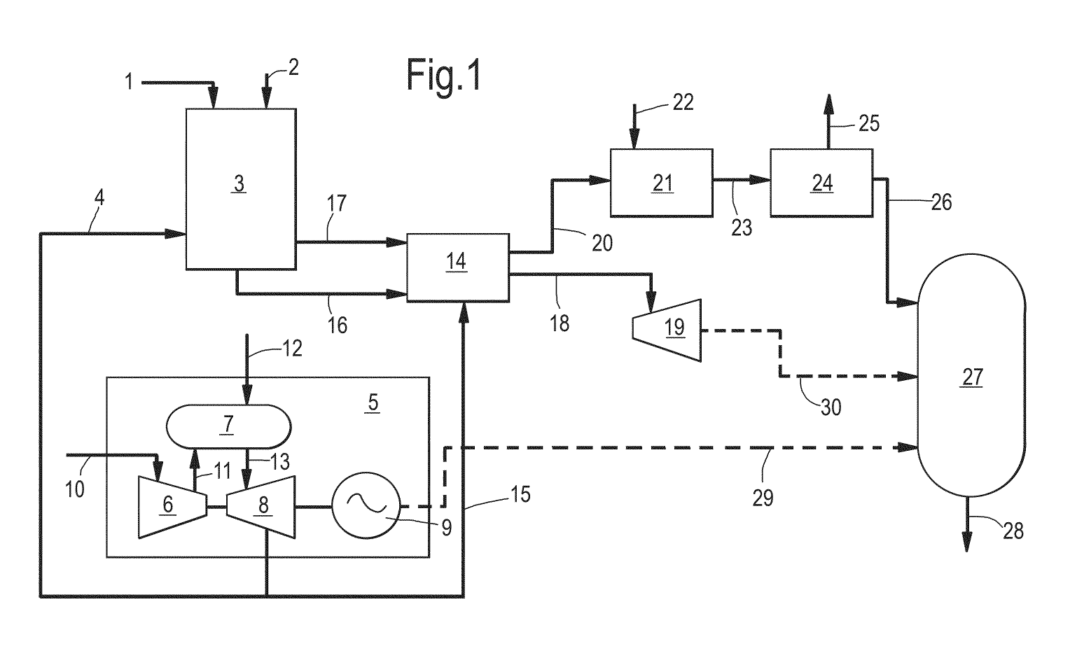

In FIG. 1, an embodiment of the invention is schematically shown wherein turbine flue gas is used for providing the heat needed for the stream reforming reaction and power generated is used for hydrogen liquefaction.

A stream of natural gas and steam are supplied via lines 1 and 2, respectively to steam reforming reaction zone 3. Heat needed for the endothermic reaction is provided by a hot gas stream that is supplied to the reaction zone via line 4. The hot gas stream is generated in gas turbine 5 comprising in series compressor 6, combustion chamber 7 and expansion turbine 8 that is directly connected to electric generator 9. A stream of air is supplied via line 10 to compressor 6, compressed to obtained compressed air that is supplied via line 11 to combustion chamber 7. Natural gas is supplied via line 12 to combustion chamber 7 as fuel and combusted to obtain a stream of combusted gas that is fed via line 13 to expansion turbine 8. In expansion turbine 8 power is generated and hot turbine flue gas is obtained of which part is supplied to the steam reaction zone via line 4 and part is supplied to heat recovery steam generator 14 via line 15 to produce steam.

In steam reforming reaction zone 3, synthesis gas is produced and cooled turbine flue gas is obtained from the heating section (not shown) which are discharged from zone 3 via lines 16 and 17, respectively, and supplied to heat recovery steam generator 14 for additional steam production. Steam produced in steam generator 14 is fed via line 18 to steam turbine 19 to generate power.

Cooled synthesis gas obtained in heat recovery steam generator 14 is supplied via line 20 to water-gas shift reaction zone 21 wherein it is converted (with steam supplied via line 22) into water-gas shifted gaseous mixture comprising hydrogen and carbon dioxide. This mixture is supplied via line 23 to carbon dioxide removal zone 24 to remove at least part of the carbon dioxide (discharged via line 25) and to obtain a gaseous stream enriched in hydrogen. This stream is supplied via line 26 to a hydrogen liquefaction unit 27 and liquefied to obtain liquid hydrogen 28. Optionally, the gaseous stream enriched in hydrogen is further purified in hydrogen by subjecting this stream to pressure swing absorption (not shown) prior to supply to hydrogen liquefaction unit 27.

Power generated in gas turbine 5 and/or in steam turbine 19 is used in liquefaction unit 27 as indicated by dotted lines 29 and 30, respectively. Steam turbine 19 may be directly connected to an electric generator (not shown) that produces electric power that is used in unit 27. Alternatively and preferably, steam turbine 19 generates shaft power that drives one or more compressors in unit 27.

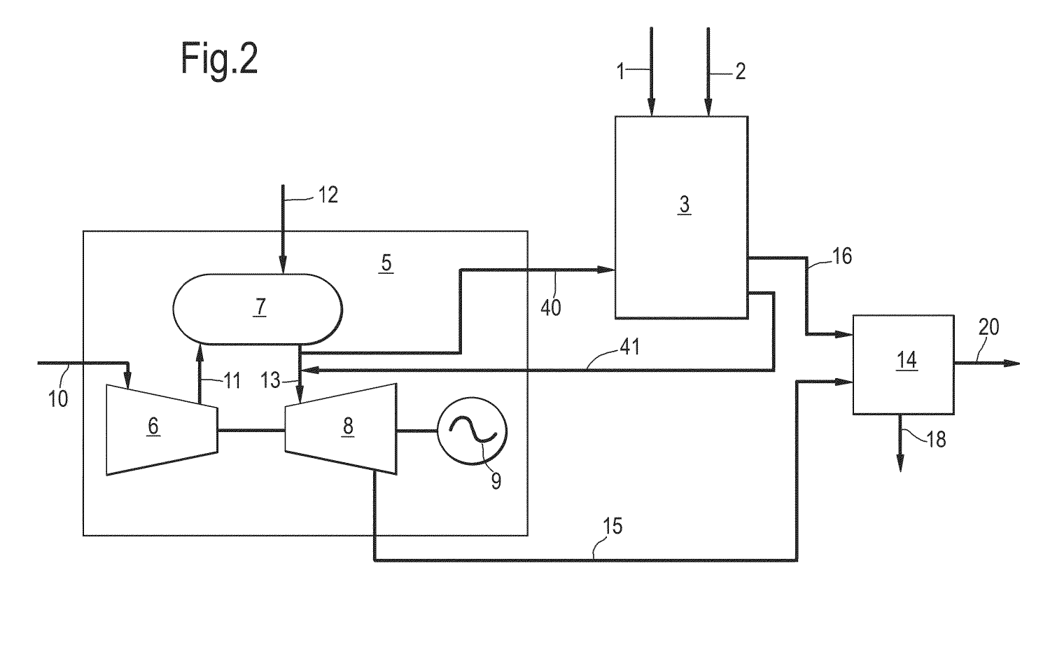

In FIG. 2, an alternative embodiment of the invention is schematically shown. Corresponding reference numbers have the same meaning as in FIG. 1. In the embodiment of FIG. 2, a slip stream of combusted gas obtained in combustion chamber 7 is supplied via line 40 to steam reforming reaction zone 3 in order to provide the heat needed for the endothermic steam reforming reaction. The gas leaving the heating zone (cooled combusted gas) is recycled via line 41 to gas turbine 5 and is combined with the combusted gas in line 13 to be supplied to expansion turbine 8.

As in the embodiment of FIG. 1, synthesis gas produced in zone 3 and turbine flue gas are supplied to heat recovery steam generator 14 via lines 16 and 15, respectively. Steam generated in steam generator 14 may be supplied to a steam turbine (not shown) via line 18 and cooled synthesis gas discharged via line 20 may be used for hydrogen recovery (not shown).

1. A process for producing hydrogen and generating power comprising the following steps:
(a) subjecting a gaseous hydrocarbon feedstock to an endothermic steam reforming reaction by contacting the hydrocarbon feedstock, in a steam reforming reaction zone, in the presence of steam, with a steam reforming catalyst under steam reforming conditions to obtain a gaseous mixture comprising hydrogen and carbon monoxide;
(b) recovering hydrogen from the mixture;
(c) feeding a fuel and an oxidant to a turbine comprising in series a compressor, a combustion chamber and an expansion turbine, wherein the compressor is coupled to the expansion turbine, wherein the oxidant is compressed in the in the compressor to obtain compressed oxidant and the fuel is combusted with the compressed oxidant in the combustion chamber to obtain a stream of combusted gas;
(d) feeding at least part of the stream of combusted gas to the expansion turbine to generate power and to obtain a turbine flue gas;
(e) providing heat for the endothermic reforming reaction by bringing a hot gas stream generated in step (c) and/or step (d) in heat exchange contact with the steam reforming reaction zone; and
(f) liquefaction of the hydrogen recovered in step (b) by subjecting the hydrogen recovered to a liquefaction cycle comprising cooling and compressing the hydrogen.

2. A process according to claim 1, wherein the hot gas stream is turbine flue gas obtained in step (d).

3. A process according to claim 2, wherein cooled turbine flue gas obtained after heat exchange contact of turbine flue gas with the steam reforming reaction zone, is further cooled by bringing the cooled turbine flue gas in heat exchange contact with water to generate steam.

4. A process according to claim 1, wherein the hot gas stream is a part of the stream of combusted gas obtained in step (c).

5. A process according to claim 4, wherein cooled combusted gas obtained after heat exchange contact of the hot gas stream with the steam reforming reaction zone, is fed to the expansion turbine.

6. A process according to claim 1, wherein at least part of the turbine flue gas is cooled by bringing the turbine flue gas in heat exchange contact with water to generate steam.

7. A process according to claim 1, wherein step (b) comprises:
(b1) cooling the mixture comprising hydrogen and carbon monoxide by bringing the mixture in heat exchange contact with water to generate steam;
(b2) subjecting the cooled mixture to a water-gas-shift reaction to obtain a water-gas shifted gaseous mixture comprising hydrogen and carbon dioxide; and
(b3) removing carbon dioxide from the water-gas shifted mixture to obtain a gaseous stream enriched in hydrogen.

8. A process according to claim 6, wherein the steam generated is fed to a steam turbine.

9. A process according to claim 8, wherein the steam turbine is drivingly connected to a compressor used for the compressing in hydrogen liquefaction step (f).

10. A process according to claim 8, wherein the steam turbine is directly connected to an electric generator to generate power.

11. A process according to claim 9, wherein the turbine and the steam turbine are combined in a combined cycle power generator.

12. A process according to claim 8, wherein the power generated in step (d) and/or in the steam turbine is used for cooling and/or compressing the hydrogen in hydrogen liquefaction step (f).

13. A process according to claim 1, wherein the gaseous hydrocarbon feedstock is natural gas.

14. A process according to claim 1, wherein the fuel fed to the turbine is natural gas.
